(19) United States
(12) Patent Application Publication
(10) Pub. No.: US 2015/0264954 A1
(43) Pub. Date: Sep. 24, 2015

(54) SOYMILK MAKER AND METHOD OF MAKING SOYMILK

(71) Applicant: KONINKLIJKE PHILIPS N.V., Eindhoven (NL)

(72) Inventors: Dong Yu, Shanghai (CN); Xiaoyun Kui, Shanghai (CN); Changjie Wang, Shanghai (CN); Abel Han, Shanghai (CN)

(73) Assignee: KONINKLIJKE PHILIPS N.V., EINDHOVEN (NL)

(21) Appl. No.: 14/431,111

(22) PCT Filed: Sep. 25, 2013
(86) PCT No.: PCT/IB2013/058835

§ 371 Date: Mar. 25, 2015

(30) Foreign Application Priority Data
Sep. 27, 2012 (CN) 201210373278.4

(51) Int. Cl. A23C 11/10

(52) U.S. Cl. CPC A23C 11/103

(57) ABSTRACT

A method of making soymilk using a soymilk maker (200, 300), said soymilk maker comprising: a container (201, 301), a grinding device (202), a heating device (203), a level sensor (204, 304) set at the upper part of said container for detecting the liquid level of the material in said container, and a water injection device (205, 305) for injecting water into said container; which method comprises the steps of: a) grinding the material, and heating the material in said container (201, 301) by applying a first power; b) during a preset period, performing a first detection using said level sensor (204, 304); and, if said level sensor is triggered by the foam generated in the process of making soymilk, heating the material in said container (201, 301) by applying a second power, said second power being lower than said first power; c) after said first detection, performing a second detection by means of said level sensor (204, 304) after a predetermined time interval; and, if said level sensor is triggered by the foam generated in the process of making soymilk, injecting water into said container, and heating the material in said container by applying said first power; if the production time does not exceed said preset period, returning to step b); if the production time is equal to or exceeds said preset period, heating the material in said container by applying a third power. The method performs detections before and after said predetermined time interval respectively; a procedure for determining and eliminating “false” triggering is in place; under secure

### FIELD OF THE INVENTION

The invention relates to an apparatus for making liquid food, in particular, to a soymilk maker capable of shortening the production time of soymilk and to a method of making soymilk.

### BACKGROUND OF THE INVENTION

Soy beverages (such as soymilk) have a high nutritional value. The production procedure for soy beverages typically includes the processes of grinding and cooking, etc. Cooking is a process of heating the soymilk, rice paste, garden produce to a serous fluid, by which the anti-nutrients are eliminated. In a food production process requiring cooking, the existing cooking process typically comprises heating the liquid by means of a heating device, and an anti-overflow process for preventing the liquid from overflowing: the liquid is heated by the heating device, and after a certain time of heating, due to the grinding by the grinding device and the rising of the temperature, the foam generated from the liquid reaches the level sensor (also referred to as anti-overflow electrode); when the level sensor is triggered in this way, the heating device will be shut down for a period of time; and after the liquid level has dropped, the liquid will be heated again; this is repeated until the temperature of the liquid reaches its boiling point and the temperature of the liquid is maintained near the boiling point for a period of time, so as to eliminate various anti-nutrients contained in the beans, after which the beverage is drinkable for the user.

### SUMMARY OF THE INVENTION

To ensure that the liquid will not overflow from the container, the existing soymilk maker, when the level sensor is triggered, will continue heating after the liquid level (which is constituted by foam) has dropped of itself and does not touch the level sensor anymore. This is repeated until the soymilk is cooked.

However, experimental data show that: when the temperature is lower than the boiling point, the foam on the liquid will not increase tempestuously; and particularly, it should be noted that when heating is stopped, the foam on the liquid gradually ruptures and makes the liquid level drop. Usually, even if most of the foam has ruptured, a portion of the foam 101 still adheres to the level sensor 102 of the soymilk maker 100 and to the wall of the container, due to the lighter mass and the adhesive power of the foam, as shown in FIG. 1. Said remaining foam and the liquid under said foam form a circuit, which will trigger the level sensor 102 sequentially. Therefore, such remaining foam will create the false impression that the liquid level is still high. The instruction to continue heating will be sent only after the remaining foam has completely dissipated. Thus, the entire production time of soymilk is prolonged. Hence, it is an object if the invention to provide a method of making soymilk and a soymilk maker, which can detect and eliminate the false impression and shorten the production time of soymilk.

To this end, a method of making soymilk with a soymilk maker is proposed; said soymilk maker comprises a container, a grinding device, a heating device, a level sensor arranged at the upper part of said container for detecting the liquid level of the material in said container, and a water injection device for injecting water into said container; said method comprises the steps of: a) grinding the material, and heating the material in said container by applying a first power; b) during a preset period, performing a first detection using said level sensor; if said level sensor is triggered by the foam generated in the process of making soymilk, heating the material in said container by applying a second power, said second power being lower than said first power; c) after performing said first detection, performing a second detection using said level sensor after a predetermined time interval; if said level sensor is triggered by the foam generated in the process of making soymilk, injecting water into said container, and heating the material in said container by applying said first power; if the production time does not exceed said preset period, returning to step b); if the production time is equal to or exceeds said preset period, heating the material in said container with a third power.

According to an embodiment of the present invention, the method of making soymilk performs a detection before and after said predetermined time interval respectively; a process for determining and eliminating the “false” triggering is provided. Therefore, under secure conditions in which the foam is eliminated, the method can be used to heat the liquid in said container to the boiling point in the shortest time, so that unnecessary waiting time is saved.

Preferably, said second power is 0.

According to an aspect of the method of making soymilk of the present invention, during said preset period, the temperature of the liquid in said container is lower than a preset temperature, said preset temperature being in a range of 95° C. to 98° C.

According to another aspect of the method of making soymilk of the present invention, said step c) further comprises: while the water is being injected, said level sensor is included in the flushed region.

Preferably, said predetermined time interval is in a range of 5 seconds to 10 seconds.

According to yet another aspect of the method of making soymilk of the present invention, in said step c), the amount of water used for injecting water into said container is in a range of 5 ml to 50 ml.

The present invention also provides a soymilk maker, said soymilk maker comprises: a container, a grinding device, a heating device, a level sensor set at the upper part of said container, characterized in that said soymilk maker further comprises: a water injection device for injecting water into said container, and a control unit for controlling said grinding device, heating device, level sensor and water injection device.

Said control unit further comprises:

a grinding-heating control subunit for grinding the material, and heating the material in said container by applying a first power;

a first detecting subunit used for: during a preset period, performing a first detection by said level sensor; if said level sensor is triggered by the foam generated in the process of making soymilk, heating the material in said container by applying a second power, said second power being lower than said first power;

a second detecting subunit used for: during said preset period, after performing said first detection, performing a second detection by said level sensor after a predetermined time interval; if said level sensor is triggered by the foam generated in the process of making soymilk, injecting water into said container, and heating the material in said container by applying said first power; if the production time does not exceed said preset period, repeating the actions of the first detecting unit; if the production time is equal to or exceeds said preset period, heating the material in said container by applying a third power.

According to an embodiment of the present invention, a water injection device for injecting water into said container is arranged in the soymilk maker, and the soymilk maker performs a detection before and after said predetermined time interval respectively; the soymilk maker is capable of determining and eliminating the “false” triggering. Therefore, under secure conditions in which the foam is eliminated, the soymilk maker can heat the liquid in said container to the boiling point in the shortest time, so that unnecessary waiting time is saved.

According to an aspect of the soymilk maker of the present invention, during said preset period, the temperature of the liquid in said container is lower than a preset temperature, said preset temperature being in a range of 95° C. to 98° C.

According to another aspect of the soymilk maker of the present invention, said water injection device is set so as to be capable of flushing said level sensor.

Preferably, said predetermined time interval is in a range of 5 seconds to 10 seconds.

According to another aspect of the soymilk maker of the present invention, the amount of water used for injecting water into said container is in a range of 5 ml to 50 ml.

According to yet another aspect of the soymilk maker of the present invention, said water injection device comprises: a water storage unit; a water outlet connected with said water storage unit; said water outlet faces said level sensor; and a water injection switch controlled by said control unit.

According to still another aspect of the soymilk maker of the present invention, said soymilk maker further comprises a machine head, said machine head being set over said container; said water storage unit is arranged in said machine head.

Preferably, said water outlet faces the upper part of said level sensor.

Preferably, said soymilk maker further comprises a temperature sensor for measuring the temperature of the liquid in said container.

### BRIEF DESCRIPTION OF THE DRAWINGS

Embodiments of the invention will be apparent from and elucidated with reference to the accompanying drawings; the invention is not limited to the description in any way; in the drawings:

FIG. 1 is a schematic diagram showing that the level sensor is triggered by remaining foam;

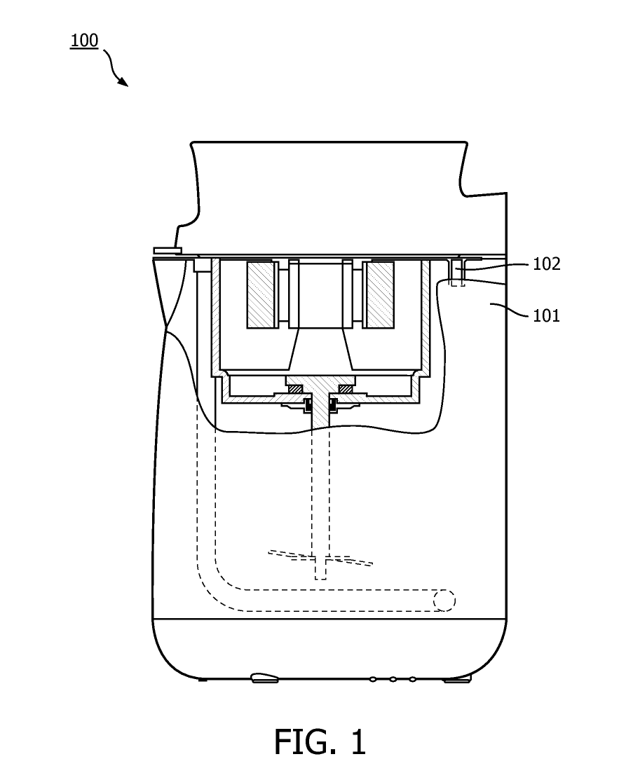

FIG. 2 is a schematic diagram of a soymilk maker according to a preferred embodiment of the invention; and

FIG. 3 is a schematic diagram of a soymilk maker according to another preferred embodiment of the invention.

Throughout the figures, like reference numerals refer to like, similar or corresponding features or functions.

### DETAILED DESCRIPTION OF THE INVENTION

Reference will now be made to embodiments of the disclosure, one or more examples of which are illustrated in the figures. The embodiments are provided by way of explanation of the disclosure, and are not meant as a limitation of the disclosure. For example, features illustrated or described as part of one embodiment may be used in another embodiment to yield a still further embodiment. It is intended that the disclosure encompass these and other modifications and variations as come within the scope and spirit of the disclosure.

In the present invention, materials for producing soy beverages may include, for example, soy beans, black beans, a mixture of legumes and vegetables, a mixture of legumes and fruits, a mixture of legumes and cereals, or any combination of these materials. The solvent may be, for example, water, mineral water, tap water, alkaline water, salt water, alcohol, or any combination of these solvents. Meanwhile, in the present invention, the term “material” can also represent any combination of the above materials and the above solvents.

For exemplary purposes only, soy beans will be used as an exemplary example of the production material and water will be used as an exemplary example of the solvent; the configuration and implementation of exemplary examples of the soymilk maker according to one aspect of the present invention will be described. It should be understood that those skilled in the art can fully understand the configuration and implementation of the apparatus when use is made of other materials and solvents.

It should be pointed out that according to the actual requirements, the method of making soymilk according to the present invention may include a grinding step, a heating step, and a cooking step. The order of said grinding step, heating step, and cooking step can be adjusted according to the actual situation. These steps are known per se, so that the description thereof is omitted here.

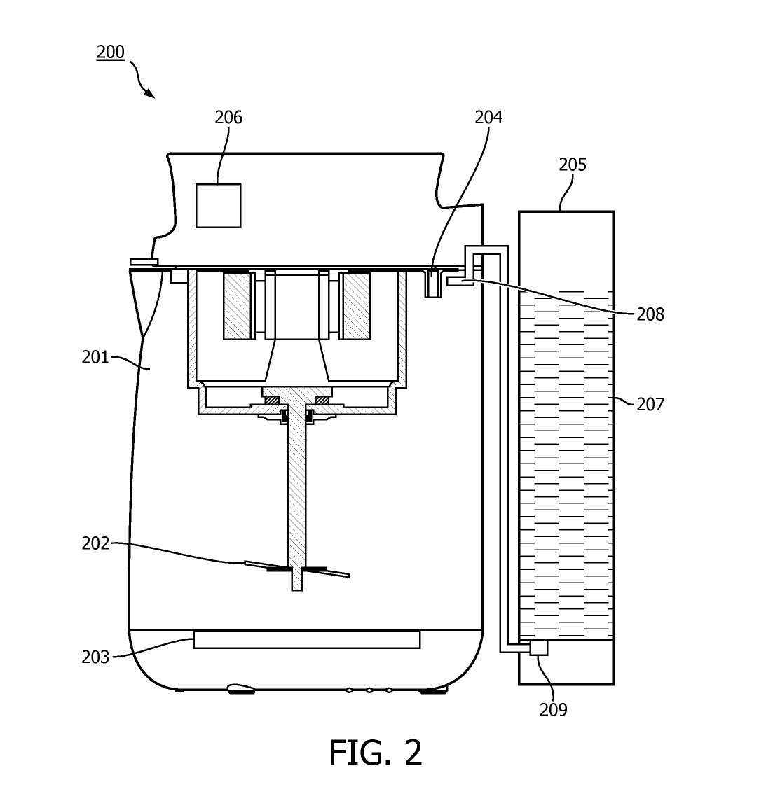

According to an aspect of the method of making soymilk according to the present invention, as shown in FIG. 2, the soymilk maker 200 for making soymilk comprises: a container 201 for containing materials; a grinding device 202 for grinding materials (the grinding device can also be used in a heating step or a cooking step to prevent the serous fluid from getting burned); a heating device 203 for heating the mixture in said container to eliminate anti-nutrients therein, so that the mixture in said container will be drinkable; said heating device 203 can be provided on the bottom of the inner side of said container 201, or below the outer side of said container 201; a level sensor 204 is set at the upper part of said container 201; when the liquid level in said container 201 rises and touches said level sensor 204, said level sensor 204 and the liquid in said container 201 constitute an electrical circuit, thereby generating a trigger signal which represents the rising of the liquid level. Said soymilk maker further comprises: a water injection device 205 for injecting water into said container 201; a control unit 206 connected with said level sensor 204 and with said water injection device 205.

Said control unit 206 is used for controlling said grinding device 202, heating device 203, level sensor 204 and water injection device 205 to make soymilk by carrying out the following steps:

a) grinding the material, and heating the material in said container 201 by applying a first power; said first power is suitable for raising the temperature of said material; preferably, said first power can be full power, or 90%, or 80%, etc;

b) during a preset period, performing a first detection by said level sensor 204; if said level sensor 204 is triggered by the foam generated in the process of making soymilk, heating the material in said container 201 by applying a second power, wherein said second power is lower than said first power; preferably, said second power may be 0; that is, the material in said container 201 is not heated, so that the previously generated foam can be reduced rapidly;

c) during a preset period, after performing said first detection, performing a second detection by said level sensor 204 after a predetermined time interval; if said level sensor 204 is triggered by the foam generated in the process of making soymilk, injecting water into said container 201, and heating the material in said container 201 by applying said first power; if the production time does not exceed said preset period, returning to step b); if the production time is equal to or exceeds said preset period, heating the material in said container 201 by applying a third power.

The method performs detection before and after said predetermined time interval respectively; a process for determining and eliminating the “false” triggering is arranged; under secure conditions in which the foam is eliminated, the method can heat the liquid in said container to the boiling point in the shortest time, so that unnecessary waiting time is saved.

Said control unit 206 can further comprise a grinding-heating control subunit, a first detecting subunit and a second detecting subunit used for performing above-mentioned actions of steps a), b) and c) respectively.

Preferably, during said preset period, the temperature of the liquid in said container 201 is lower than a preset temperature, said preset temperature being in a range of 95° C. to 98° C. When the temperature is lower than said preset temperature, the liquid in said container 201 is not apt to boil violently. Thus, the liquid level can be controlled well to prevent the liquid from overflowing by performing detection using the level sensor 204. Said preset period can be determined based entirely on time. For example, a period for heating the liquid in said container to said preset temperature by applying a certain power can be stored in said control unit 206; or, said preset period can be determined directly according to the actual temperature of the liquid in said container 201.

When the temperature is higher than said preset temperature, the liquid is apt to boil violently. Thus, a third power corresponding to 50%˜80% of the full power can be applied for heating to prevent the liquid from boiling violently. Meanwhile, when the temperature is close to the boiling point, as the vaporization of the solvent in the materials is high, the foam generated by the grinding of the grinding device 202 and the heating of the heating device 203 will rupture more easily. That is, the “false” triggering is not apt to happen. Therefore, when the temperature is higher than said preset temperature, the level sensor 204 can be set in a normal operating mode. In this normal operating mode: a third power is used for heating; when the level sensor 204 is triggered by the foam, the heating power should be reduced until the electric al circuit between the level sensor 204 and the foam is opened; then said third power is used for heating again. This is to be repeated until the cooking step is finished.

Said water injection device 205 is set to be capable of flushing the liquid level. Said water injection device 205 injects water into said container 201, the upper layer of the liquid and the level sensor can be flushed such that the foam on the upper layer of the liquid and the foam adhered to said level sensor 204 will rupture. After the remaining foam is eliminated, the liquid in said container 201 and the level sensor 204 will not constitute an electrical circuit anymore, so that the liquid in said container 201 will not keep triggering said level sensor.

Preferably, said water injection device 205 is set to be capable of flushing said level sensor 204. That is, when water is being injected, said level sensor 204 is included in the flushed region, or, the flushed region only includes said level sensor 204. With such a configuration, the water injection device 205 can take full advantage of the injected water to flush said level sensor 204. The electrical circuit constituted by the liquid and said level sensor 204 can be opened with as little water as possible; thus, the temperature of the liquid in said container will not drop rapidly. Preferably, in said step c), the amount of water used for injecting water into said container 201 is in a range of 5 ml to 50 ml. As only a small amount of water is injected, the temperature of the liquid will not drop rapidly, and the possibility of excessively diluting the liquid in said container (i.e. the concentration of finished product such as soymilk being too low) will be avoided.

In one embodiment, said predetermined time interval is in a range of 5 seconds to 10 seconds. Firstly, time is necessary for rupturing the foam, so that the liquid level can drop effectively. Secondly, after said predetermined time interval, the rupturing of the foam will slow down; if there is a “false” triggering now, the “false” triggering will probably continue for a relatively long time. Therefore, if the level sensor 204 is still triggered after said predetermined time interval, then waiting is not necessary, the liquid level and/or said level sensor 204 can be flushed immediately.

In a preferred embodiment, the water injection device 205 can comprise: a water storage unit 207 for storing water which is used to flush the liquid level and/or said level sensor 204; a water outlet 208 connected with said water storage unit 207, for example, through a water pipe; said water outlet 208 can face said level sensor 204 such that said level sensor 204 can be flushed directly; and a water injection switch 209 controlled by said control unit 206.

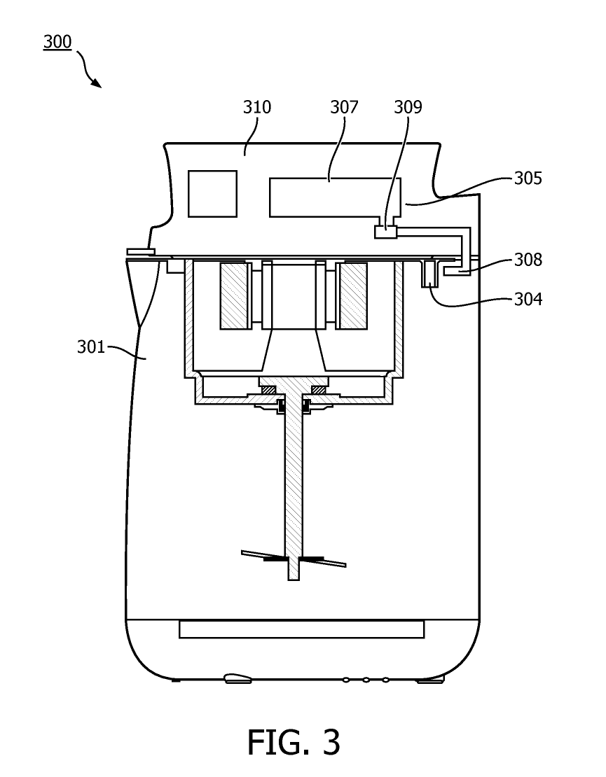

In another preferred embodiment, as shown in FIG. 3, the soymilk maker 300 can further comprise a machine head 310. Said machine head 310 can be set over the container 301. Preferably, said water storage unit 307 can be arranged in said machine head 310. With such a configuration, the water storage unit 307 of the water injection device 305 is integrated within the soymilk maker, enabling the soymilk maker to have a compact structure, and to be assembled or arranged easily.

Preferably, the water injection switch 309 can be a pump or an electromagnetic valve. Preferably, the level sensor 304 can be arranged on the lower side of the machine head 310 or on the inner wall of the container 301, and said water outlet 308 is arranged so as to face the upper part of said level sensor 304. With such a configuration, the injected water can flush said level sensor in a direction from top to bottom due to gravity. As compared to the mode where the entire level sensor is flushed, this flushing mode uses less water every time the sensor is flushed.

Optionally, the soymilk maker can further comprise a temperature sensor (not shown) for measuring the temperature of the liquid in said container. Said temperature sensor can be arranged on the wall of the container, on the bottom of said container, or on said level sensor. With the temperature sensor, the temperature of the liquid in said container can be measured accurately, and the preset period can be determined exactly.

As previously described, the solvent for producing the beverage may be, for example, water, mineral water, tap water, alkaline water, salt water, alcohol, or any combination of these solvents, so that the “water” used in said water injection device (as well as in said water storage unit) can be modified to be the specifically used solvent.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. In addition, singular references do not exclude a plurality. Thus, references to “a”, “an”, “first”, “second” etc do not preclude a plurality. Reference signs in the claims are provided merely as a clarifying example and shall not be construed as limiting the scope of the claims in any way.

1. A method of making soymilk with a soymilk maker, said soymilk maker, comprising: a container, a grinding device, a heating device, a level sensor set at the upper part of said container for detecting the liquid level of the material in said container, and a water injection device for injecting water into said container;
said method comprises the steps of:
a) grinding the material, and heating the material in said container by applying a first power;
b) during a preset period, performing a first detection by said level sensor; if said level sensor is triggered by the foam generated in the process of making soymilk, heating the material in said container by applying a second power, said second power being lower than said first power;
c) after performing said first detection, performing a second detection by said level sensor after a predetermined time interval; if said level sensor is triggered by the foam generated in the process of making soymilk, injecting water into said container, and heating the material in said container by applying said first power; if production time does not exceed said preset period, returning to step b); if the production time is equal to or exceeds said preset period, heating the material in said container by applying a third power.

2. The method according to claim 1, characterized in that said second power is 0.

3. The method according to claim 1, characterized in that during said preset period, the temperature of the liquid in said container is lower than a preset temperature, said preset temperature being in a range of 95° C. to 98° C.

4. The method according to claim 1, characterized in that said step c) further comprises:
while the water is being injected, said level sensor is included in the flushed region.

5. The method according to claim 1, characterized in that said predetermined time interval is in a range of 5 seconds to 10 seconds.

6. The method according to claim 1, characterized in that in said step c), the amount of water used for injecting water into said container is in a range of 5 ml to 50 ml.

7. A soymilk maker comprising:
a container;
a grinding device;
a heating device;
a level sensor set at the upper part of said container,
characterized in that said soymilk maker further comprises:
a water injection device (245, 1-05 for injecting water into said container; and
a control unit for controlling said grinding device, heating device, level sensor) and water injection device; said control unit further comprises:
a grinding-heating control subunit for grinding the material, and heating the material in said container by applying a first power;
a first detecting subunit used for: during a preset period, performing a first detection by said level; if said level sensor, is triggered by the foam generated in the process of making soymilk, heating the material in said container by applying a second power, said second power being lower than said first power;
a second detecting subunit used for: during said preset period, after performing said first detection, performing a second detection by said level sensor fail, after a predetermined time interval; if said level sensor is triggered by the foam generated in the process of making soymilk, injecting water into said container, and heating the material in said container by applying said first power; if a production time does not exceed said preset period, repeating the actions of the first detecting unit; if the production time is equal to or exceeds said preset period, heating the material in said container by applying a third power.

8. The soymilk maker according to claim 7, characterized in that during said preset period, the temperature of the liquid in said container is lower than a preset temperature, said preset temperature being in a range of 95° C. to 98° C.

9. The soymilk maker according to claim 7, characterized in that said water injection device is set so as to be capable of flushing said level sensor.

10. The soymilk maker according to claim 7, characterized in that said predetermined time interval is in a range of 5 seconds to 10 seconds.

11. The soymilk maker according to claim 7, characterized in that the amount of water used for injecting water into said container is in a range of 5 ml to 50 ml.

12. The soymilk maker according to claim 7, characterized in that said water injection device comprises:
a water storage unit;
a water outlet connected with said water storage unit; said water outlet faces said level sensor; and
a water injection switch controlled by said control unit.

13. The soymilk maker according to claim 12, characterized in that said soymilk maker further comprises a machine head, said machine head being set over said container; said water storage unit is arranged in said machine head.

14. The soymilk maker according to claim 12, characterized in that said water outlet faces the upper part of said level sensor.

15. The soymilk maker according to claim 7, characterized in that said soymilk maker further comprises a temperature sensor for measuring the temperature of the liquid in said container.
